(19) United States
(12) Patent Application Publication
(10) Pub. No.: US 2022/0318929 A1
(43) Pub. Date: Oct. 6, 2022

(54) System and Method for Automated Electronic Tax Preparation and Filing

(71) Applicant: Blackspark Corporation, Toronto (CA)

(72) Inventors: Ramon Tavares, Toronto (CA); Vivek Arora, Toronto (CA); Charles Baptiste, Toronto (CA); Francisco Gonzalez, North York (CA)

(73) Assignee: Blackspark Corporation, Toronto (CA)

(21) Appl. No.: 17/482,970

(22) Filed: Sep. 23, 2021

Related U.S. Application Data
(60) Provisional application No. 63/168,379, filed on Mar. 31, 2021.

(51) Int. Cl. G06Q 40/00; G06F 40/174; G06F 40/186

(52) U.S. Cl. CPC G06Q 40/123; G06F 40/174; G06F 40/186

(57) ABSTRACT

A system and method for automating the process of gathering information from taxpayers for tax practitioner-filed tax returns. The system and method automates the collection of taxpayer information from multiple sources to pre-populate a digital tax file prior to gathering information from a taxpayer. The tax information automatically collected and loaded (e.g. pre-populated) is organized in standardized digital tax files for every taxpayer, per tax year. The standardized digital tax file is automatically generated and the standardized format created enables the automation of tax preparation and filing workflows.

### FIELD

The present application generally relates to a system and method for electronic tax preparation and filing, and in particular automation of the process of gathering information from taxpayers for practitioner-filed tax returns.

### BACKGROUND

The majority (e.g. approximately %) of electronically filed personal tax returns in North America are prepared and filed by practitioners (e.g. accountants) on behalf of taxpayers. The other approximately ⅓ of electronically filed personal tax returns are prepared by taxpayers using Do-It-Yourself (DIY) software such as for example TurboTax to prepare and file their own tax return.

Conventional solutions in the field of practitioner-filed tax returns comprise software applications (e.g. on-premise and cloud) that are used by practitioners (e.g. accountants/tax preparers at tax firms or tax preparation companies) to prepare tax returns by manually entering taxpayer data into the software user interface. Typically, this process is combined with one or more of various methods of retrieving the taxpayer data that is required to prepare the tax return:
Sending the taxpayer a “tax organizer” or questionnaire for the taxpayer to complete (e.g. typically a paper-based form or electronic equivalent, such as PDF);
Allowing the taxpayer to physically deliver hard copies of tax forms (e.g. income slips) and financial statements to the practitioner's office;
Allowing the taxpayer to email (or upload to a shared web folder) electronic copies of tax forms (e.g. income slips) and financial statements;
Conducting an in-person, phone or web-based interview to ask the taxpayer questions about their tax situation and then manually entering the data; and
Subsequently, asking the taxpayer follow-up questions about any missing information that is required to complete the tax return.
   It would be advantageous to provide alternative methods and systems for gathering information from taxpayers and for preparing and filing tax returns.

### SUMMARY

The system and method of the present application provides an alternative solution for practitioner-filed returns. A benefit of the present system and method is that it is a more efficient process for the taxpayer to provide the information required for the tax practitioner to prepare and file their tax return. Another benefit of the present system and method is that it provides a significant reduction in the preparation time required for a tax practitioner to complete and file a tax return. Advantages of the system and method of the present application may also include for example an improved taxpayer experience for the preparation of their personal income tax return, secure communication of tax and personal information, and reduced cost for a tax practitioner (e.g. accountant) to prepare a return tailored for each taxpayer.

The present application describes a system and method for electronic tax preparation and filing. Particularly, the system and method provides automation at scale, for example the end-to-end automation of the tax preparation process (e.g. Canada T1). The system and method of the present application automatically seeds (e.g. locates and inputs data) data into the system from external data sources (e.g. tax authority, Canada Revenue Agency (CRA), and 3^{rd} party/vendor tax applications). As well, the system and method of the present application provides an individual (e.g. taxpayer) with a web-based workflow for easy review of their seeded data and the ability to supplement with additional required details, without tax practitioner intervention. Also, the system and method of the present application automates the communication process between the taxpayer and their tax practitioner (e.g. replaces direct communication between the parties), including for example onboarding, getting required authorizations signed and reminders for specific pieces of data required to complete the tax return.

A method for automating the collection of tax information for a tax return, the method comprising retrieving tax information from external data sources over a communications network; generating a digital tax file; pre-populating the received information into the digital tax file; and providing the information in the digital tax file to a taxpayer via an online portal.

The method may further comprise determining completeness of the populated digital tax file; generating a customized user interaction sequence based on the taxpayer's information, wherein the sequence facilitates the receipt of additional information and approval of the tax file from the taxpayer. The method may further comprise transmitting and filing the digital tax file via the communication network. The method may further comprise initiating a tax preparation process with the taxpayer; provisioning a taxpayer account for access to a client portal; and obtaining consent from the taxpayer to access external data sources.

### BRIEF DESCRIPTION OF THE DRAWINGS

Reference will now be made, by way of example, to the accompanying drawings, which show example embodiments of the present application.

FIG. 1 shows a block diagram of a system for automating tax preparation, according to an example embodiment of the present application;

FIG. 2 shows a process for automating the engagement and onboarding of taxpayer users, in accordance with an example embodiment of the present application;

FIG. 3 shows a process for tax authority authorization, in accordance with an example embodiment of the present application;

FIG. 4 shows a standardized digital document in accordance with an example embodiment of the present application;

FIG. 5 illustrates an overall process for gathering, reviewing and filing a tax return according to an example embodiment of the present application;

FIGS. 6 to 9 show example screenshots of a client portal in accordance with an example embodiment of the present application;

FIG. 10 illustrates interaction between system components for data gathering in accordance with an example embodiment of the present application; and

FIGS. 11A to 11C illustrate an example reductive user interface experience according to an example embodiment of the present application.

### DETAILED DESCRIPTION OF EXAMPLE EMBODIMENTS

The system of the present application provides a streamlined, modernized, web-based interaction for taxpayers. The system absolves taxpayers of the need to organize paper documents and drop off at a tax practitioner's office or to organize and upload electronic documents to their tax practitioner. The majority of taxpayer effort is shifted from data entry to data review (e.g. enabled via seeding and pre-population from existing data sources). The system ensures completeness of the tax file (e.g. taxpayers don't have to guess whether they have provided all necessary information, as the system keeps track for them and sends reminders). In the majority of cases, the taxpayer need only review the data that has already been collected by the system on their behalf.

In one aspect, the present application describes a system and method for automating the collection and data entry of tax information. The system and method of the present application provides an improved taxpayer data gathering process that is less burdensome for the taxpayer (e.g. less data entry, less organization and transmission of documents to their accountant). The system is able to initially retrieve and reconcile taxpayer data from multiple sources (e.g. the prior-year return and data from tax authorities, 3^{rd} party/vendor tax applications) to automatically seed (e.g. pre-populate data fields) a current year electronic file (e.g. a “Tax file” object in the system) for the taxpayer. This is done prior to gathering information directly from the taxpayer. The system automatically organizes all retrieved taxpayer data into the relevant categories (e.g. named “sections” in the system) that, in their entirety, are required to complete the tax return. The system then, based on the pre-loaded data for the taxpayer, automatically designs a customized web-based interaction for the taxpayer to review and confirm the accuracy of the retrieved information and provide any missing details. Also the system and method automatically ensures that all required information is collected from each taxpayer. For example, system and method may request from the taxpayer a binary assertion on whether each section (e.g. of a tax form) is applicable, or not.

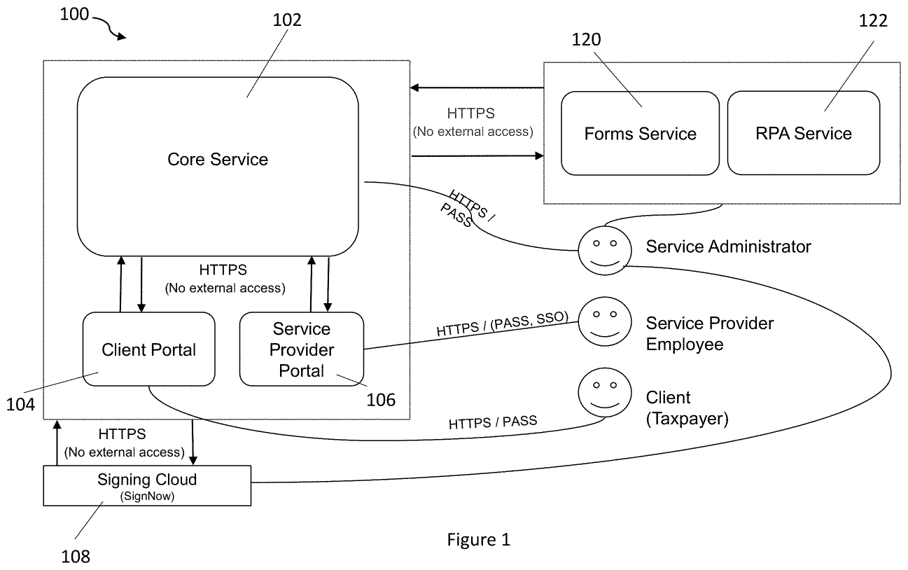

As well, the system and method is scalable as it may automate the loading of taxpayer data for multiple taxpayers and from multiple data sources (e.g. authorization list, CRA, etc.). The tax information automatically collected and loaded (e.g. pre-populated) is then organized in standardized (e.g. predetermined, consistent format), digital tax files for every taxpayer, per tax year (e.g. one tax file database record for each taxpayer per tax year). The standardized digital tax file for every taxpayer is automatically generated and the digital tax file enables the automation of subsequent workflows. The digital tax files (e.g. Tax File database object) are designed with a standard format that is used for every taxpayer. The standardized organization of information enables the automated preparation and filing of the tax return without requiring manual review (e.g. by an accountant). Although not required, the standardized information may also facilitate quick and accurate review by a tax preparer at any stage of completion through the service provider portal 106. The digital tax files may be accessed by service provider employees through the service provider portal 106 user interface at any stage of the tax file completion. In some embodiments the information from the standardized digital tax file for every taxpayer may also be outputted in a format for easy review by an accountant (e.g. indexed PDF). The digital tax file also enables the creation and storage of any required file formats throughout the overall preparation process (e.g. the electronic facsimiles of T-slips presented to the taxpayer are generated (e.g. by the forms service in FIG. 1) using the data that was collected from the tax authority (e.g. CRA) and stored in the Tax File database object. For example, PDF copies of the T1 tax return and addenda are generated from the data in the digital tax file.

In another aspect, the present application describes a system and method for the secure communication of tax and personal information between an individual (e.g. taxpayer) and a tax preparer (e.g. accountant). The method automatically provisions a web-based, login account to access the system for every taxpayer. In an example embodiment, the system automatically communicates with taxpayers to initiate the tax preparation process (e.g. onboarding/login workflow, engagement workflow and CRA authorization workflow).

The system may leverage enterprise automation to replace ad-hoc and manual processes done by human resources. As well, the system may enforce standardization across the handling of all sensitive data (e.g. the system does not deviate from the configured security context). A benefit of the system is that it provides consistency of security of tax files and information.

The automated engagement and onboarding of all taxpayers makes the system more efficient than conventional solutions. For example, taxpayers may be onboarded with only names and email addresses. The system guides taxpayers through the engagement workflow, including authorizations for additional family members, and automatically provisions a unique web-based login account for each taxpayer. The system of the present application facilitates a significant reduction in tax return preparation time, which may result in a cost reduction for tax preparation. By automating taxpayer communications, standardizing the electronic tax file for every taxpayer and enforcing a binary assertion (e.g. by the taxpayer) on every data point required for the return, the system reduces the time required by an accountant to review and finalize the tax return. The system significantly increases the number of tax returns that a tax practitioner (e.g. accountant) can review and finalize, in a given time period.

The systems and methods of the present application may be software implemented or may be implemented as software as a service (SaaS), SaaS system, a web application. In other embodiments the systems and methods may be computer implemented, processor implemented or software implemented, or a combination thereof.

Other aspects and features of the present application will be understood by those of ordinary skill in the art from a view of the following description of examples in conjunction with the accompanying figures.

Reference is first made to FIG. 1, which illustrates a simplified block diagram of a system 100 for automating tax preparation in accordance with an example embodiment of the present application. The system 100 includes a core service 102, a client portal 104, a service provider portal 106, a signing service 108, a forms service 120 and a process automation service 122. The various components of the system 100 may be combined (e.g. fewer overall components) or additional components may be included within the system. The system components may communicate with each other over a communications network (e.g. Internet, HTTPS, cellular network, wireless network).

The system 100 may be implemented on a server, web server, SaaS or may be cloud based or any combination thereof. In the example embodiment, the core service 102, the client portal 104 and the service provider portal 106 are implemented using a cloud-based platform such as for example Salesforce Cloud. As well, in the example embodiment, the forms service 120 and the process automation service 122 are implemented using a cloud-based platform such as for example Amazon Web Services (AWS).

In the example embodiment and as shown in FIG. 1, the system 100 components communicate with each other over a secure internet connection (e.g. HTTPS). Clients (e.g. taxpayers) and service provider users access their respective portals over a secure internet connection. Access to the client portal 104 and service provider portal 106 requires a password to be inputted. The service provider administrator accesses the core service 102 over a secure internet connection and via a password.

The core service 102 is the primary application of the system 100. In the example embodiment, the core service 102 is deployed on a cloud platform (e.g. Salesforce) that provides an integrated server and database. The core service 102 orchestrates interactions of other system 100 components and interactions with users. Users may include for example the system service administrator, service provider employees and clients (e.g. taxpayers). The core service 102 facilitates the integration of external data sources (e.g. taxpayer data retrieved from tax authority, government tax agency, CRA).

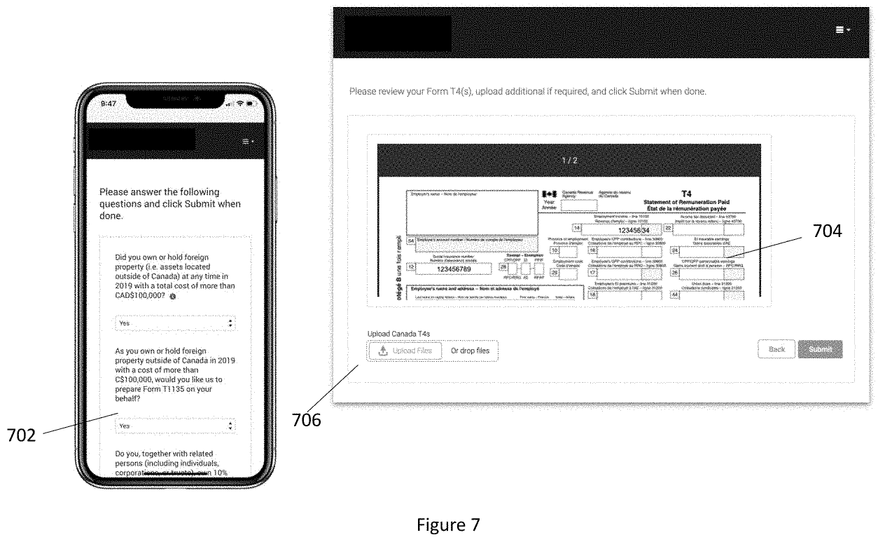

The client portal 104 functions as a user interface for individuals (e.g. taxpayer). In the example embodiment, the client portal 104 is implemented on a cloud-based platform (e.g. Salesforce using Communities licenses). Access to the client portal 104 is secure and password protected. The taxpayer may access the client portal 104 through the internet for example using a smartphone, tablet or computer device. The client portal 104 provides the taxpayer with an organized view of data (e.g. tax information, personal information etc.) relevant to their tax return. The information shown to the taxpayer in the client portal 104 has been accessed from external data sources (e.g. taxpayer data retrieved from CRA) and the information is pre-populated into one or more electronic tax forms or one or more web-based interfaces, or a combination of both. For example, the one or more electronic tax forms may represent one or more tax slips (e.g. T4, T3 etc. that were issued to the taxpayer). The client portal 104 guides the taxpayer through a sequential and tailored interaction (e.g. webpages, user interface screens etc.) to review data and provide any missing details that are required for tax preparation. As well, the client portal 104 allows the taxpayer to submit support requests, questions and upload documents. FIG. 7 illustrates example screenshots of the client portal 104. Screen 702 shows example questions presented to the taxpayer. Screen 704 shows an example electronic representation of a tax form (e.g. T4) for the taxpayer to review the data contained therein. Button 706 allows a client to upload documents. Clients (e.g. taxpayers) may sign-up directly with the service provider or external tax preparers may provide a list of their clients to be onboarded. The system 100 enables onboarding of clients (e.g. taxpayers) one at a time and also enables onboarding of multiple clients through the loading and processing of an authorization list (e.g. .CSV file). Client onboarding uses a few pieces of information (e.g. name, email address, agreed price, etc.) and the system 100 automatically creates the contact, account and digital tax file records for every taxpayer, as well as provisions the web-based client portal 104 login for the primary taxpayer. Secondary taxpayers on the account (e.g. spouse, children requiring tax preparation) may have their respective portal logins created automatically by the system 100 as part of the onboarding and engagement workflows.

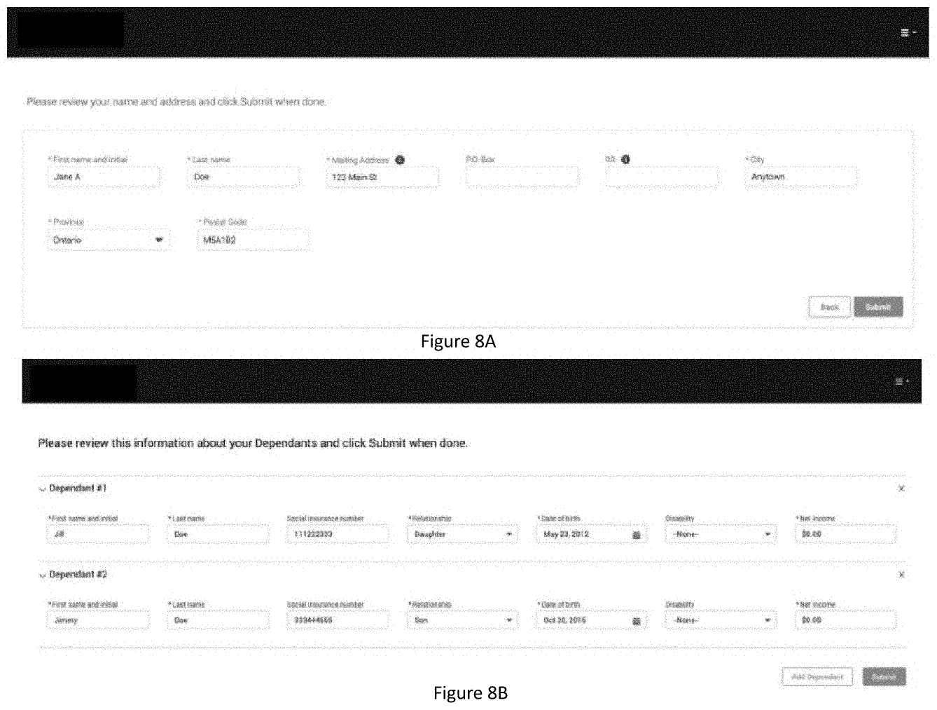

The forms service 120 is a processing system for tax forms. In the example embodiment, the forms service 120 is deployed on a cloud service (e.g. Amazon Web Services) and communicates with the core service 102 (e.g. over a network, internet). The forms service 120 reads and processes forms that are supplied (e.g. uploaded) to the system and the service 120 extracts data for insertion into the digital tax file for the taxpayer (e.g. database record). Forms service 120 also retrieves data in a raw format (e.g. CSV file) from the relevant tax authority and potentially other third party sources and extracts the data for insertion into the digital tax file. Forms may include previous year tax returns, tax slips (e.g. T3, T4, T4A, T5 etc.). As well, the forms service 120 may generate electronic representations of forms that resemble (e.g. mimic) the conventional or original format of tax forms and slips (e.g. CRA T-slips). The forms service 120 enables configuration of the form templates (e.g. x/y coordinates of fields, etc.) required to process forms. For example, this may include matching data fields from the original data source to the new electronic forms (e.g. taking tabular data from a .csv file and populating the new forms). The process automation service 122, in the example embodiment, runs in a virtual cloud environment (e.g. no on-premise hardware required). For example, the service 122 may be deployed on a cloud service (e.g. Amazon Web Services, RPA) and communicates with the core service 102 (e.g. over a network, internet). The process automation service 122 enables integration and workflow extension to external GUI-based applications where no API connectivity is available (for example, external application CCH iFirm, a 3^{rd} party web-based tax software). FIGS. 8A and 8B illustrate example screens of the client portal 104 with pre-populated information such as name and address information for a taxpayer.

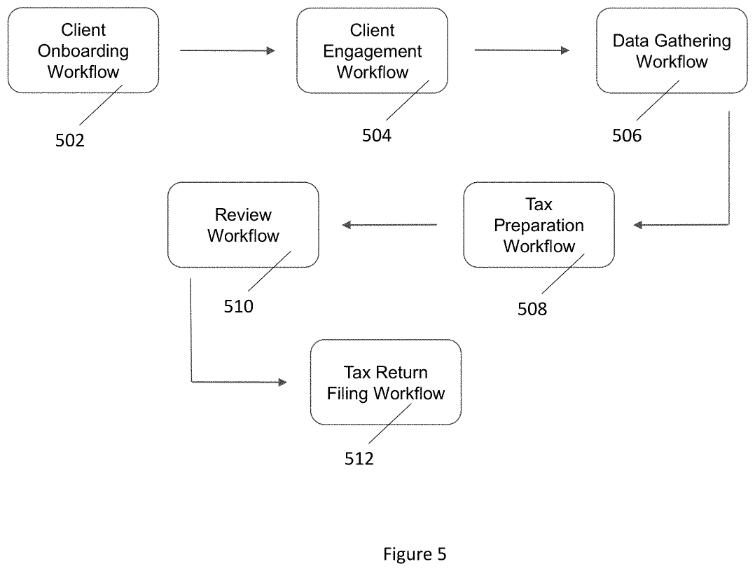

The service provider portal 106 is a user interface for employees, consultants etc. of the service provider (e.g. tax service provider system users may include accountants and tax preparers). In the example embodiment, the portal 106 is deployed on a cloud service (e.g. Salesforce cloud platform). Access to the service provider portal 106 is secure and password protected. The service provider may access the service provider portal 106 through the internet for example using a smartphone, tablet or computer device. The portal 106 contains client files and related forms that have been pre-populated by the core service 102 to integrate external data sources (e.g. taxpayer data retrieved from CRA). The user interface of the service provider portal 106 also permits the viewing of the information in the standardized electronic tax file (not shown). On the portal 106, service provider users may view reporting on electronic tax files (e.g. data collected, status, level of completion). For example, the status or level of completion of a tax file may be identified by the stage of the overall automated workflow the file is currently in, such as engagement, gathering, preparation etc. (for example, see FIG. 5 for workflow stages). As well, the portal 106 allows service provider users to send ad-hoc communications to taxpayers (e.g. requests for additional information). Also, the portal 106 allows service provider users to respond to client (e.g. taxpayer) support requests. In other embodiments, the service provider portal 106 allows the filing of the tax return. As well, the portal 106 may have functions for service provider users (e.g. accountants and tax preparers) to manually trigger the engagement and gather workflows for a taxpayer, if required (e.g. rather than automated batch processing for multiple taxpayers).

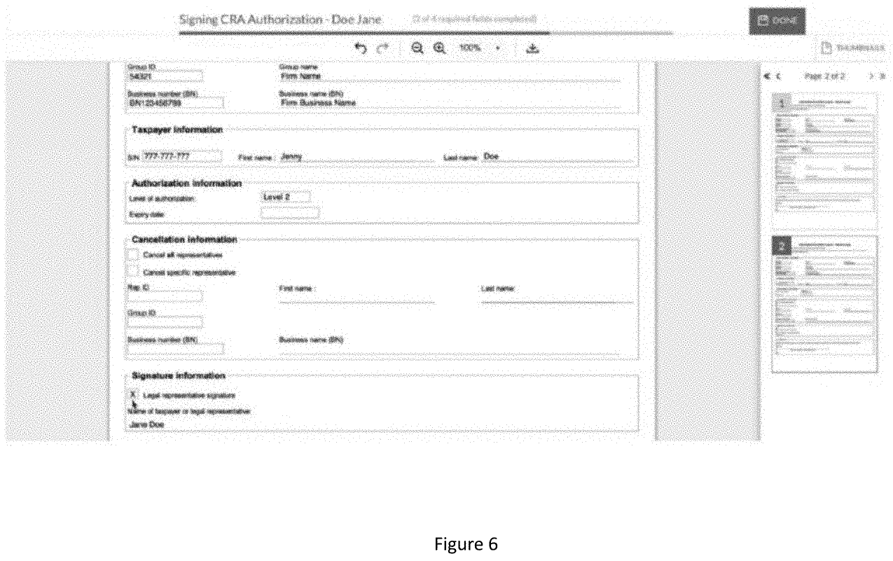

The system 100 automates the creation, communication, distribution and storage of signed documents for all taxpayers. The signing service 108 integrates with 3rd party electronic signature platforms. For example, the signing service 108 communicates with the core service 102 to 3rd party platforms (e.g. SignNow, DocuSign) via a secure internet connection (e.g. HTTPS). Clients (e.g. taxpayers) authorize the service provider to obtain and access tax authority data through the client portal 104 or the signing service 108. This enables the core service's 102 automation of collection of authorizations required from taxpayers (e.g. CRA My Representative Service authorization, T183 Authorization to File, etc.). FIG. 6 shows an example screen in the client portal 104 for a client to e-sign a CRA authorization.

The system 100 runs and facilitates the automation of workflows that in conventional tax preparation solutions comprise the typical back-office operations at a tax firm or tax preparation company for tax return services. FIG. 5 illustrates an overall process for gathering, reviewing and filing a tax return according to an example embodiment of the present application. The core service 102 orchestrates the overall process and various workflows shown in FIG. 5. The workflows include client onboarding 502, client engagement 504, data gathering 506, tax preparation 508, review 510 and tax return filing 512.

The process starts with client onboarding 502. The core service 102 automatically creates system objects for each client (e.g. Tax File, Contact, Account). For example, a Tax File and Account objects are automatically created for a primary taxpayer. The Tax File and Account objects include contact information for the primary taxpayer. As well, a portal user account is created for the primary taxpayer. Next, the process proceeds to client engagement 504. This includes for example requesting client confirmation of engagement and automatically executing CRA authorization process. If applicable, Tax File and Contact objects for additional taxpayers (i.e. other taxpayers in the household) are created. The primary taxpayer is directed to the client portal 104 to confirm and accept the engagement (e.g. agree to the automated tax service). As part of the client engagement 504, the taxpayer confirms that they authorize a third party (e.g. the service provider, tax practitioner) to access the taxpayer's records with the relevant tax authority (e.g. Canada Revenue Agency (CRA) authorization). The taxpayer confirms the tax authority authorization through the client portal 104 and may electronically sign an authorization document. The signed document may be stored and accessed through the service provider portal 106. The core service 102 connects to the tax authority (e.g. CRA) and files the tax authority authorization document (e.g. CRA authorization).

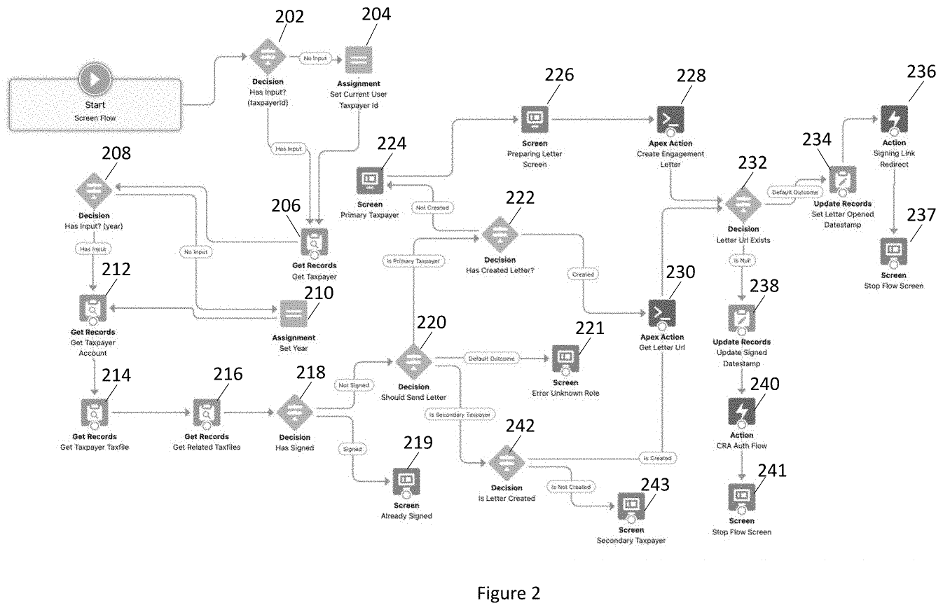

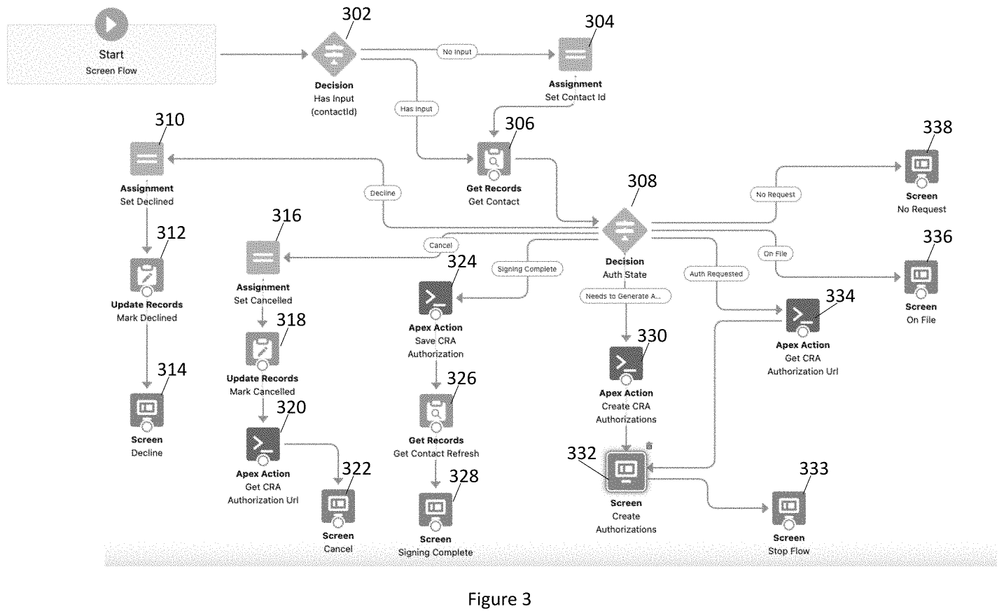

FIG. 2 illustrates a more detailed process to automate the engagement and onboarding of a tax client according to an example embodiment of the present application (e.g. further details of client onboarding workflow 502 and engagement workflow 504). The process of FIG. 2 is performed automatically by the core service 102 and facilitates communications, ability to collect and store e-signatures, ability for taxpayers to authorize preparation for additional family members/dependants and provisioning secure portal access. Additional input may be requested from the taxpayer via the client portal 104. No service provider input is required for the process of FIG. 2. First, it is determined whether the tax client is an existing client (e.g. have a taxpayer ID) or is a new client (e.g. no taxpayer ID) (block 202). If it is a new tax client, then the client is assigned a unique identifier (e.g. taxpayer ID) (block 204). If it is an existing tax client, then the taxpayer information for that client is located (e.g. retrieving database records, SQL queries) (block 206). Next, it is determined what is the tax year (block 208). If no tax year is specified, the year is set to the current tax year (block 210). After the year is set in block 210, or if a year has been inputted in block 208, the taxpayer account is located and accessed (block 212), as well as the taxpayer Tax File is located and accessed (block 214) and any related Tax Files (block 216) (e.g. spouse Tax File). Next, it is determined if the tax client has signed the required documents (e.g. signed authorization letter on file for the taxpayer) to receive tax service through the system (block 218). If the client has signed, then a screen is displayed confirming the client has already signed and the process ends (block 219). If the client has not signed, then it is determined whether a letter should be sent to the client (block 220). If the client is neither a primary or secondary taxpayer, then the process proceeds to an unknown role screen (block 221). If client is a secondary taxpayer, then it is determined if a letter has already been created (block 242). If no letter has been automatically created yet, then a secondary taxpayer screen is shown (block 243). If a letter has been created, then a link (e.g. URL) to the letter is obtained (block 230). From block 220, if the client is a primary taxpayer, then it is determined whether a letter has previously been created (block 222). If no letter has been created, a primary taxpayer screen is displayed (block 224) and a further screen to facilitate the preparation of the letter (block 226) and a new engagement letter is generated (block 228). At block 232 its determined if a letter URL exists. If no URL exists, then the client letter has been signed and the records are updated to indicate the client has signed the letter (block 238) and then the process continues to a CRA authorization process (block 240, details of this process shown in FIG. 3) and once completed the process ends (block 241). If the URL for the letter exists, the letter is opened and records are updated accordingly (block 234), the client is directed to a signing page (block 236) and the process ends (block 237).

FIG. 3 illustrates a more detailed process for tax authority (e.g. CRA) authorization for a tax client according to example embodiment (e.g. further details of client engagement workflow 504). The process in FIG. 3 is a sub-flow of the onboarding and engagement process of FIG. 2. This process provides for creating tax authority authorization, and updating taxpayer authorizations (e.g. if taxpayer declines or cancels authorization). First, it is determined whether an identification has been entered (e.g. contact ID) for the tax client (block 302). For each client (e.g. taxpayer) there is a Contact record (Contact ID) and a Role record (e.g. Taxpayer ID), and the various workflows may require either of these identifiers or both. If no input, then a new contact ID is assigned (block 304). Then the process gets the records associated with the contact ID (block 306). At block 308 the authorization state (e.g. status) is determined. If authorization is declined, this status is assigned (block 310), the records are updated (e.g. marked as declined) (block 312) and the decline screen is displayed (block 314) and the process ends. If authorization is cancelled, this status is assigned (block 316), the records are updated (e.g. marked as cancelled) (block 318), the authorization URL is obtained (e.g. to decline the outstanding e-sign invitation through third party platforms) (block 320) and the cancel screen is displayed (block 322) and the process ends. The authorization states are automatically determined by the workflow depending on existing records associated with the contact ID and on the client (e.g. taxpayer) actions (e.g. taxpayer declines to sign when reviewing authorization letter on third party platform). If the state is that signing has been completed, the authorization is saved (block 324), the records are updated to include the authorization (block 326) and the signing complete screen is displayed (block 328) and the process ends. If the state is that authorization needs to be generated, the authorizations are generated (e.g. created) (block 330) and the create authorization screen is displayed (block 332) and the process ends (block 333). If the state is that authorization is requested, the authorization URL is obtained (block 334), and the create authorization screen is displayed (block 332) and the process ends (block 333). If the authorization state is on file, meaning the authorization has already been obtained and recorded, the on file screen is displayed (block 336) and the process ends. If there is no authorization request, the no request screen is displayed (block 338) and the process ends.

The system 100 may maintain or generate a report of all onboarded taxpayers and their authorization status (e.g. approved, declined, or cancelled). The report may include information including taxpayer name, SIN number, contact information (e.g. email address), related tax returns (e.g. spousal return) and administrative contact information.

After the client onboarding 502 and client engagement 504 workflows, data is gathered 506 for the digital tax file (e.g. Tax File database object). This step includes gathering all data from 3rd party sources, pre-populating digital tax files and determining relevance of data to taxpayer to create a customized client portal interaction. All known tax data is gathered from various sources (e.g. 3^{rd} party tax applications, such as Taxprep, tax authority, CRA data download, manual input). The design and implementation of the system enables collection of every data point required to complete a tax return (e.g. approximately 2,500 data fields), as well as reconciliation of that data when being retrieved from multiple sources. The web-based form processing is designed to enable the automatic creation of tax forms, allowing the system to convert raw, tabular financial information (e.g. in database or .csv format) into nearly identical electronic versions of tax forms that the taxpayer would normally receive from tax authorities, employers or financial institutions (e.g. income slips delivered by mail).

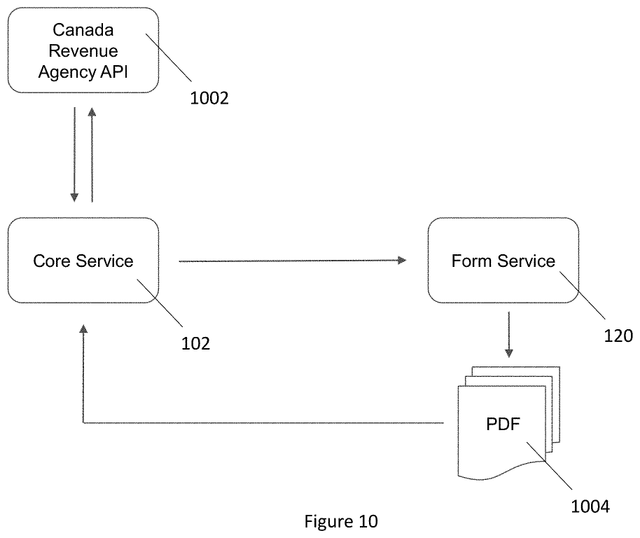

FIG. 10 illustrates the interaction between system components for the data gathering workflow 506 in accordance with an example embodiment of the present application. The core service 102 electronically communicates with the tax authority 1002 (e.g. CRA) to request and receive relevant tax information for the digital tax file. For example, the system may utilize the tax authority API (e.g CRA API) to retrieve the data information and slips that the tax authority has on file for each taxpayer. As well, the tax slip data for a taxpayer (e.g. T4, T3 etc.) is generally stored on the tax authority database as raw data fields. The system 100 of the present application takes this raw data and uses it to create electronic slip facsimiles (e.g. copies, replicas) using the form service 120. The core service 102 may also receive relevant data from other third party sources or from input from the taxpayer via the client portal 104. The core service 102 creates section objects with the retrieved data. If the section represents a tax form (e.g. a CRA form), the core service 102 transmits the form data to the form service 120. The form service 120 creates PDF representations 1004 of tax forms using the retrieved data and form templates. The form service 120 has implemented templates for all required tax forms (e.g. CRA forms). In the example embodiment, each template has two electronic files. A first file is a JSON file that maps all fields in a form (e.g. X,Y coordinates, Type (text, date, currency, number, choice, checkbox), formatting information). A second file is a PDF representing a blank (e.g. unfilled) form. The form service 120 is a micro-service that receives tax data from the core service 102 and receives a request from the core service 102 for form creation to map the data to specific fields in the mapping template (e.g. {FieldId1: Value1, FieldId2: Value2 . . . etc.} and applies the data received from the core service 102 into the forms. The data values are written to a copy of the PDF form using the information from the template. The form service 120 may be implemented using a cloud service (e.g. AWS Fargate, Docker container).

As described above, the system 100 uses raw financial data to create an electronic representation of tax slips which facilitates in-line, contextual review by taxpayers during the data collection process. Data and tax-specific information is presented to the taxpayer in a familiar format that is easy to reconcile with their own records. For example, the slips (e.g. income slip) presented to them by the system will look nearly identical to the slip they normally receive in the mail from their employer, financial institution, tax authority, etc. Therefore, they can quickly confirm the accuracy of the information. For example, the system 100 provides for the automatic seeding of digital tax files with information from external data sources. This process may include the reconciliation of multiple sources of identical information to an authoritative source, for each data point. On-screen images (e.g. electronic representation of tax slips) shown on the system 100 will look like (e.g. have the same appearance) as the tax slips a taxpayer receives from CRA, their employer, issuer etc. Therefore, a taxpayer may simply review the on-screen version in the client portal 104 and does not have to scan, email, photocopy, upload etc. a copy of their tax slips. As the online image looks like the original slips, this further aids in the taxpayer's quick review of the information. Similarly, the electronic representation of the slips is also available for the tax practitioner users inside the service provider portal 106, to facilitate quick and simplified review of the taxpayer's information.

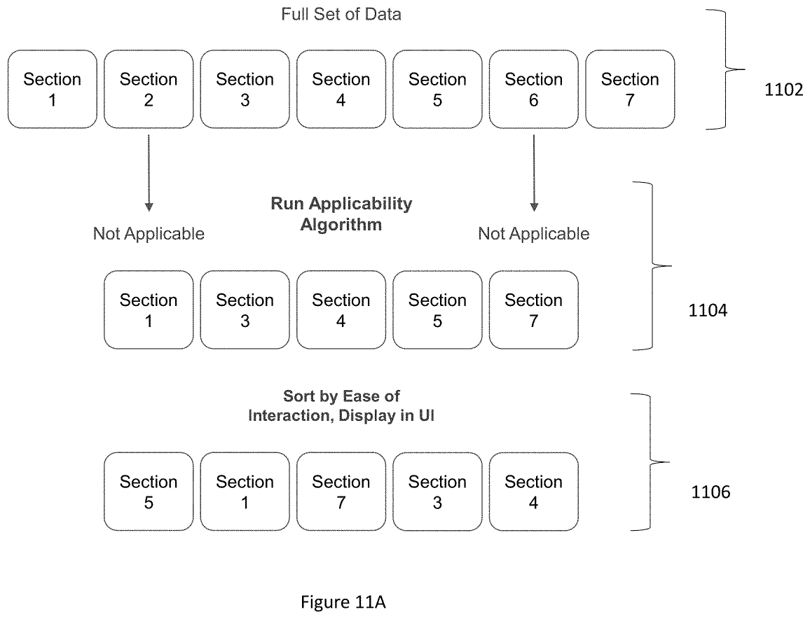

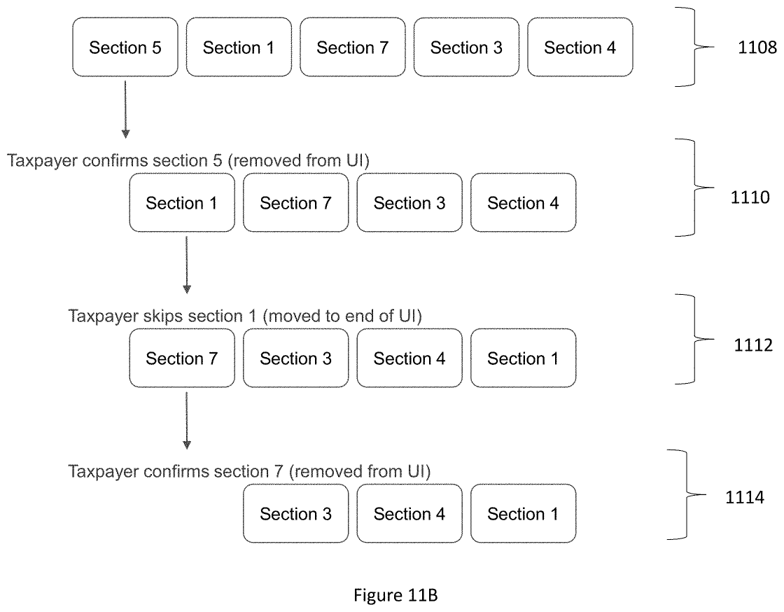

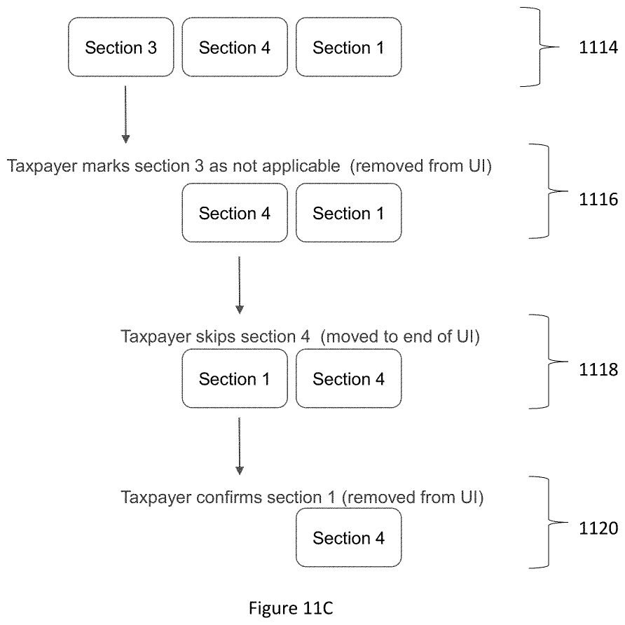

Next, as part of the data gathering workflow 506, the relevance of data to the taxpayer is determined to create a customized client portal interaction. That is, the information in the digital tax file is leveraged to create the customized web-based data gathering interaction for the taxpayer. The state (e.g. whether a section is applicable to a taxpayer or not) for each section of the digital tax file is updated. For example, sections that are determined to be not applicable to a taxpayer's current digital tax file are marked as such and therefore will not be shown to the taxpayer in their customized user interaction. Similarly, sections that are determined to be applicable (e.g. because a certain data point or slip such as T4 was collected from a third party source) will be marked as such and the algorithm will prioritize and sequence that section accordingly in the customized user interaction (e.g. FIG. 11A). The data from the digital tax file is then organized into a customized user interface (e.g. bespoke user experience) that is displayed to the taxpayer in the client portal 104. The core service 102 automatically sends a notification to the taxpayer that their digital tax file is ready for their input and confirmation. The client portal 104 facilitates a reductive user interface experience until taxpayer has confirmed or inputted all required data.

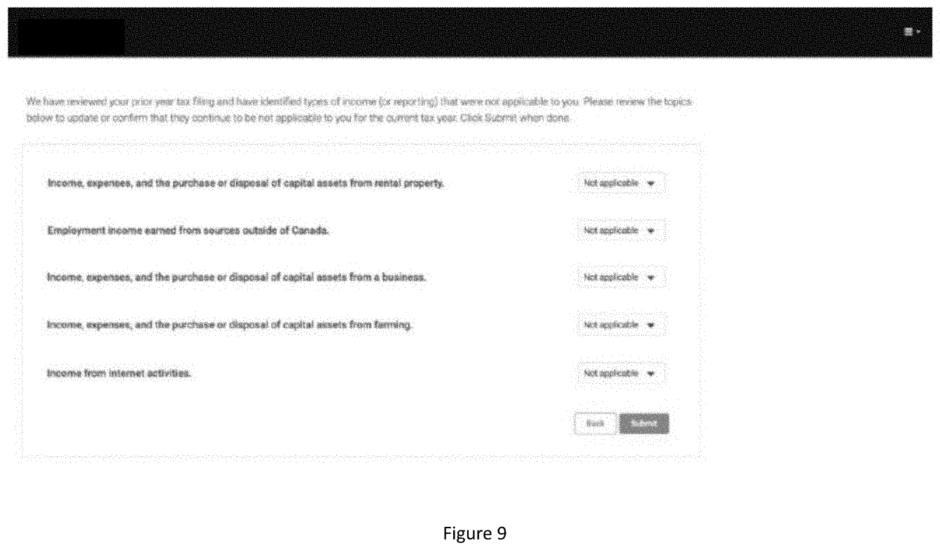

The system 100 creates a customized web-based, data gathering process for each taxpayer user (e.g. system determines and presents the relevant questions, information etc. to be shown to the taxpayer) based on the information available from previous year tax returns and other details known about their specific circumstances for the current tax year. The web-based user interface is designed to allow taxpayers to securely review and confirm the accuracy of the electronic versions of tax forms created by the system (and other information relevant to the preparation of their tax return). The web-based user interface is also dynamic, as it is designed to absolve the taxpayer from entering redundant information regarding their current year tax return (e.g. fields are pre-populated with retrieved information). As well, the user interface absolves the taxpayer from reviewing or entering information that is not applicable to their current year tax return (e.g. less common sections of the tax return are presented as a digest of topics, allowing the taxpayer to quickly confirm whether they apply to them or not). FIG. 9 shows an example screen in the client portal 104 where a client can update or confirm if certain circumstances apply to them, for example rental property income, income earned from sources outside Canada etc.

The data gathering process also automates the sequence and scheduling of interactions with the taxpayer. The system and method of the present application sequences the web-based interaction in the most efficient manner for the taxpayer (e.g. simple and easy-to-complete sections are presented first, more complex sections are presented later). The process presents the taxpayer with data collected that is specific to their tax return (e.g. T-slips, data from their prior-year return). The interaction with the taxpayer is sequenced based on presumption of applicability to the specific taxpayer's return, of each data point required to prepare the return. Sequencing enables the multitude of data points to be presented in the most user-friendly fashion (e.g. required and simple data first, presumed applicable data second, presumed not applicable data last). This ensures that interactions are relevant to the taxpayer's situation and as concise as possible.

Additionally, the system and method of the present application creates a reductive data gathering experience, meaning once a taxpayer has reviewed and completed a given section, it is removed from view in the user interface, thereby letting the taxpayer know when they have completed the process. FIGS. 11A to 11C illustrate an example reductive user interface experience according to an example embodiment of the present application. In the example shown, a first reductive algorithm includes obtaining all available data for the digital tax file (e.g. forms created by CRA Auto Fill my Return, all pre-populated tax file data, other external or remote data sources). Next, a full set of data is sequenced by section (1102) (e.g. in the logical order of a tax return file, according to object data model). Then the algorithm determines applicability of tax form sections based on various conditions (1104). For example, the algorithm may determine if a section is applicable to their current situation (e.g. have a rental property). Some sections will always be required and cannot be considered not applicable (e.g. name, address). The sections that are determined to be not applicable to the taxpayer are eliminated from visibility to the client in the user interface (e.g. shown in client portal 104). Next, sections are then sorted by ease of interaction and sequenced accordingly (1106) (e.g. simple to complete sections are located first, more complicated sections later). A second reductive algorithm is performed as shown in the examples FIGS. 11B and 11C as the taxpayer navigates the user interface in the client portal 102 to review and/or provide data section by section. As shown in 1108, the sections in the user interface are organized based on the last step 1106. The taxpayer may confirm or edit and confirm the information in a section (1110, 1114). The record (e.g. section) is marked as completed and removed from the user interface (UI) and the UI advances to the next section. As well, the taxpayer may skip a section, which results with the section being moved to the end of the UI (e.g. to appear again later) and the UI advances to the next section (1112, 1118). The taxpayer may also mark a section as not being applicable to them (1116). The section is recorded as not applicable in system database, and the section is removed from UI and the UI advances to next section. As the taxpayer completes sections, they are removed from view in the UI. In the example, at 1120 the taxpayer cannot skip section 4. If confirmed or marked as not applicable, taxpayer has finished the workflow. Once no sections remain, the taxpayer is done submitting information and the overall core automated process continues to the tax preparation workflow 508. With the present system and method, the taxpayer is assured that they have addressed all of the topics that are required for their practitioner to prepare their tax return. That is, as the web-based data gathering process is both thorough and reductive, the taxpayer will know when they have finished the process and will have more assurance that they have not missed providing important details (e.g. versus conventional solutions where their practitioner ask open-ended questions such as “What income and expenses did you have this year?).

The system 100 facilitates submission of support requests by the taxpayer (e.g. taxpayer may submit support request through client portal 104) and automatically routes to the service provider (e.g. notifications to the service provider and/or available on service provider portal 106).

Next, tax preparation 508 is performed. In this step, the system 100 automatically prepares the tax package (e.g. Canada T1 package including forms and data in an electronic format ready for electronic filing via for example CRA EFILE API). All information received in the client digital tax file is used to automatically prepare a tax package (e.g. Canada T1 package). In the example of a Canadian tax return, this includes for example automatically preparing a T1 tax return and supporting schedules (e.g. for example all tax forms) and data is prepared in a format ready for electronic tax filing (e.g. EFILE required fields are compiled from the digital tax file). After the client information is gathered, a standardized digital tax file is generated that contains all the information required to automatically prepare, review and file the tax return. The generated digital tax file is logically sequenced and consistent for each taxpayer to facilitate automated tax preparation.

The digital tax file (e.g. tax data, tax return) is then reviewed 510. In this step, the system 100 automatically reconciles data and identifies exceptions. This includes the system 100 reconciling the data automatically and identifying any exceptions (e.g. missing information, incorrect information etc.). For example, reconciling one or more data points of the received information with one or more alternate remote data sources. The system 100 automatically creates tasks (e.g. if required) for the service provider and/or taxpayer to resolve exceptions. An advantage of the present system and method is that the tax practitioner does not have to intervene in the taxpayer data gathering process. The taxpayer interacts with the system directly (e.g. through the web-based UI) to provide the data required to prepare the tax return. Notifications (e.g. letting the taxpayer know via email that their data is ready for review) and reminders (e.g. that they have not yet finished) are also automated by the system, absolving the tax practitioner from having to manage these communications.

The system 100 may send notifications to indicate that new tasks are available in the service provider portal 106 and/or the client portal 104. An advantage of the present system and method is that the practitioner receives a digital tax file at an advanced stage of completion. Once the taxpayer has completed the web-based interaction, the digital tax file contains all (or almost all) of the information required to finalize and electronically file the tax return with tax authorities. As well, another advantage of the present system and method is that the practitioner receives a digital tax file that is highly standardized. The system generates a digital tax file that is identical in layout from one taxpayer to another. This significantly reduces the time required for the practitioner to review the information, if required, or confirm its completeness.

After the exceptions (if any) are resolved, the system 100 completes the tax return filing 512 process. The system 100 automatically assembles relevant tax forms for electronic filing and a summary of the tax results (e.g. T183 form/bundle). As well, the system 100 requests authorization and/or e-signature from the taxpayer and payment for tax preparation service via the client portal 104. Next, the system 100 automatically assembles the tax return (e.g. T1 bundle). This includes assembling the tax & benefit return, provincial tax return and all pertaining schedules and forms. The system 100 automatically electronically files tax return (e.g. CRA EFILE integration). As a result of creating a complete and standardized digital tax file (e.g. database record) for each taxpayer, the system is able to integrate directly (e.g. via API) with tax authority electronic filing services to automatically file the tax return. The forms service is also leveraged again at this stage to generate all of the supporting documentation (e.g. the tax return and addenda in electronic format such as PDF) to deliver to the taxpayer, or provide as backup to tax authorities (e.g. to address inquiries and audits).

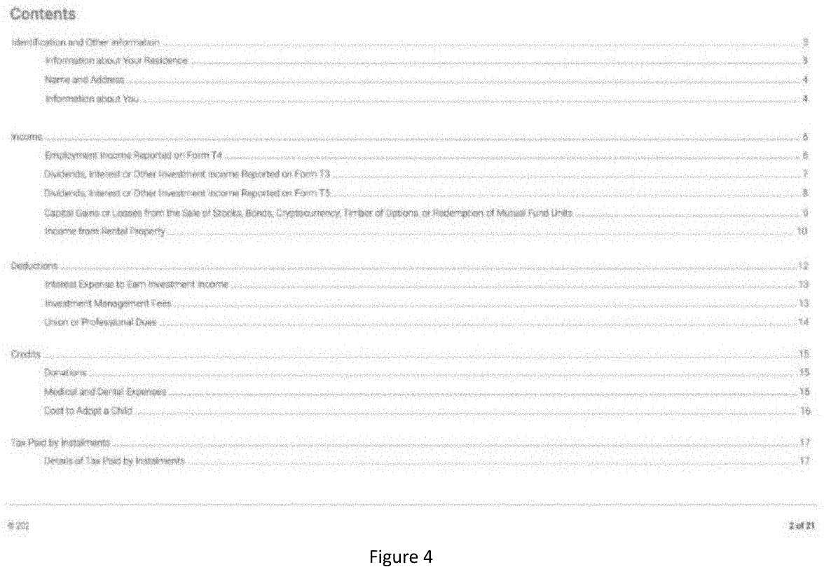

As well, the system 100 saves and stores final documents such as proof of filing, a copy of return and notice of assessment (if available). The documents (e.g. proof of filing, copy of return etc.) are automatically made available through client portal 104 for taxpayer download. As well, the documents are stored and archived for the taxpayer for each tax year. Documents, tax file information and taxpayer information is stored in a database in the system (e.g. core service 102). FIG. 4 illustrates a standardized digital document (e.g. indexed PDF) that may also be generated in accordance with an example embodiment of the present application. For every taxpayer the standardized digital document may automatically be generated and outputted in a format for easy review by an accountant (e.g. indexed PDF). The system may also maintain other standardized electronic files for each client including for example client profile and other related information.

The example embodiments are generally described in the context of the Canadian tax return preparation and filing. However, the system and method of the present application may be utilized for tax return preparation and filing in other countries and with other national tax authorities. As well, the system and method of the present application may be modified to apply to a different field of application (e.g. other government and/or regulatory filings). Certain adaptations and modifications of the described embodiments can be made. Therefore, the above-discussed embodiments are considered to be illustrative and not restrictive.

1. A method for automating the collection of tax information for a tax return, the method comprising:
retrieving tax information from one or more remote data sources over a communications network;
pre-populating the received information into a digital tax file; and
displaying the information in the digital tax file to a taxpayer over the communications network.

2. The method of claim 1, further comprising:
reconciling one or more data points of the received information with one or more alternate remote data sources.

3. The method of claim 1, further comprising:
generating one or more form templates for one or more tax documents;
mapping the received information to data fields in the one or more form templates.

4. The method of claim 1, generating one or more filled form templates using the information in the digital tax file.

5. The method of claim 1, wherein the information displayed to the taxpayer includes electronic images representing one or more tax slips.

6. The method of claim 1, further comprising:
generating the digital tax file in a standardized format, wherein the format of the digital tax file enables the automation of tax preparation and filing processes.

7. The method of claim 1, further comprising:
pre-populating the received information into one or more user interfaces.

8. The method of claim 1 further comprising:
electronically filing a tax return using the information in the digital tax file via the communication network.

9. The method of claim 1 further comprising:
initiating a tax preparation process with the taxpayer over the communications network;
provisioning a taxpayer account for access to a client portal; and
obtaining electronic consent from the taxpayer to access remote data sources.

10. The method of claim 1 further comprising:
determining completeness of the populated digital tax file; and
generating a customized sequence for a user interface based on the information in the digital tax file.

11. The method of claim 10, wherein the user interface facilitates the receipt of additional information and approval of the digital tax file from the taxpayer.

12. The method of claim 10, wherein the step of generating the customized sequence includes:
positioning one or more sections of the digital tax file on the user interface in the order of a conventional tax return;
determining the applicability of the one or more sections to the taxpayer based on the information in the digital tax file; and
removing the one or more sections from the user interface that are determined not applicable.

13. The method of claim 12, further comprising:
sorting the one or more sections based on ease of user interaction; and
positioning the one or more sections in the order of highest ease of user interaction first.

14. The method of claim 12, wherein when the one or more sections of the digital tax file are completed by the taxpayer, the one or more sections are removed from the user interface.

15. The method of claim 14, further comprising:
reviewing the taxpayer completed digital tax file for errors and omissions.

16. The method of claim 9, wherein access to the client portal is secure.

17. The method of claim 1, further comprising:
organizing the received data into categories that are required to complete the tax return.

18. A system for automatic tax preparation, the system comprising:
a database for storing data related to a tax file;
a processor, wherein the processor is configured to:
retrieve tax information from one or more remote data sources over a communications network;
pre-populate the received information into a digital tax file; and
display the information in the digital tax file to a taxpayer over the communications network.

19. A non-transitory computer readable medium having instructions stored thereon, which when executed by a processor for automatic tax preparation, the processor performs the method of claim 1.
